(19) United States
(12) Patent Application Publication
(10) Pub. No.: US 2025/0217352 A1
(43) Pub. Date: Jul. 3, 2025

(54) INTERACTIVE QUERY SYSTEMS AND METHODS

(71) Applicant: Allstate Insurance Company, Northbrook, IL (US)

(72) Inventors: Marvin LU, Chicago, IL (US); Peter BOUCHARD, Chicago, IL (US); Katherine Rose SWINDLER, Chicago, IL (US); Morgan MOSKY, Chicago, IL (US); Reuel Neil JOSE, Vernon Hills, IL (US); Umamaheshwar R. UPPADA, Palatine, IL (US); Raja Sekhar THIRUVATHURU, Aurora, IL (US); Thomas CROSSE, Chicago, IL (US)

(21) Appl. No.: 18/969,662

(22) Filed: Dec. 5, 2024

Related U.S. Application Data
(60) Provisional application No. 63/615,881, filed on Dec. 29, 2023.

(51) Int. Cl. G06F 16/242; G06F 16/248

(52) U.S. Cl. CPC G06F 16/2423; G06F 16/243; G06F 16/248

(57) ABSTRACT

Implementations claimed and described herein provide systems and methods for responding to a query associated with a product or service. The systems and methods use a machine learning model to generate a recommendation and a user interface. The recommendation is transmitted to a user device for display via the user interface.

### CROSS-REFERENCE TO RELATED APPLICATIONS

The present application claims priority to U.S. Provisional Patent Application No. 63/615,881 filed on Dec. 29, 2023, which is incorporated by reference in its entirety herein.

### FIELD

Aspects of the presently disclosed technology relate generally to systems and methods for generating an interactive query interface and more particularly to an artificial intelligence agent for interacting with one or more consumers.

### BACKGROUND

Complex products and services can be overwhelming for an ordinary consumer to understand. Training staff on the nuances of the different products and services to be responsive to consumer questions and requests for information often involves considerable resources, including time and expense. Further, staff resources are typically limited, resulting in extended waiting periods before consumers can connect with staff. On the other hand, computer-generated bots are often limited to providing predefined answers to narrowly tailored questions. Such computer-generated bots are unable to understand varying questions and provide relevant information according to the nuances of the underlying complex products and services. It is with these observations in mind, among others, that various aspects of the present disclosure were conceived and developed.

### SUMMARY

Implementations described and claimed herein address the foregoing problems by providing systems and methods for query resolution. The systems and methods herein provide technical improvements to human-computer interaction (HCl), such as, for example, conventional computer-generated chatbots, by allowing for complex conversations between a user and computer implementing the systems and methods described herein. For instance, conversations regarding complex products and services are optimized such that a user is comfortable with interacting with the system when making a complex purchase.

In some implementations, a computer implemented method can comprise: generating an interactive query interface for presentation using one or more output systems, receiving query input associated with at least one of a product or a service, the query input captured via one or more input systems through interaction of a user with the interactive query interface, generating a query based on the query input using a natural language processing system, receiving user data associated with the user, generating a recommendation based on the user data and the query using a machine learning model, and causing the interactive query interface to present the recommendation using the one or more output systems.

In some implementations, a system comprises a provider system in communication with a user device over a network, the user device having one or more input systems and one or more output systems, the provider system configured to generate an interactive query interface, the provider system receiving query input captured via the one or more input systems through interaction of a user with the interactive query interface, the provider system receiving user data from the user device, a natural language processing system configured to generate a query based on the query input, the query associated with at least one of a product or a service, and a recommendation system having a machine learning model, the recommendation system configured to generate a recommendation based on the user data and the query using the machine learning model, the provider system configured to send the recommendation to the user device to cause the recommendation to be presented with the interactive query interface using the one or more output systems.

In some implementations, one or more tangible non-transitory computer-readable storage media store computer-executable instructions for performing a computer process on a computing system, the computer process comprising: generating an interactive query interface for presentation using a user device, receiving query input associated with at least one of a product or a service, the query input captured via the user device through interaction of a user with the interactive query interface, generating a query based on the query input using a natural language processing system, receiving user data associated with the user, generating a recommendation based on the user data and the query using a machine learning model, and causing the interactive query interface to present the recommendation using one or more output systems.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example query system.

FIG. 2 illustrates an example provider system.

FIG. 3 illustrates an example computing system that may implement various aspects of the query system.

FIG. 4 illustrates example operations for query resolution.

FIGS. 5-9 illustrates an example interactive query interface providing a coverage review.

### DETAILED DESCRIPTION

Aspects of the present disclosure involve systems and methods query resolution. In some aspects, an interactive query interface is generated for interaction with one or more consumers to capture and respond to complex queries through a guided and personalized experience. A machine learning model of a recommendation system is trained using historical data relating to one or more products and services. The interactive query interface captures input using one or more input systems. The query system generates a query by digesting the input using a natural language processing system. The machine learning model of the recommendation system analyzes the query and generates a response. The interactive query interface presents the response using one or more output systems. Additional advantages of the presently disclosed technology will become apparent from the detailed description below.

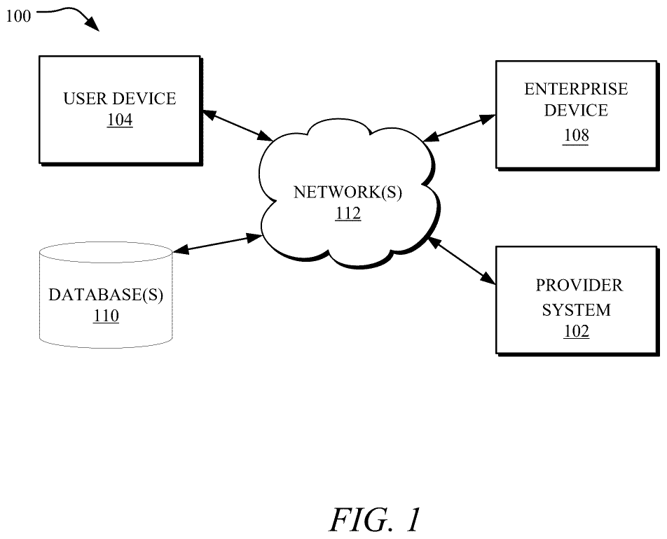

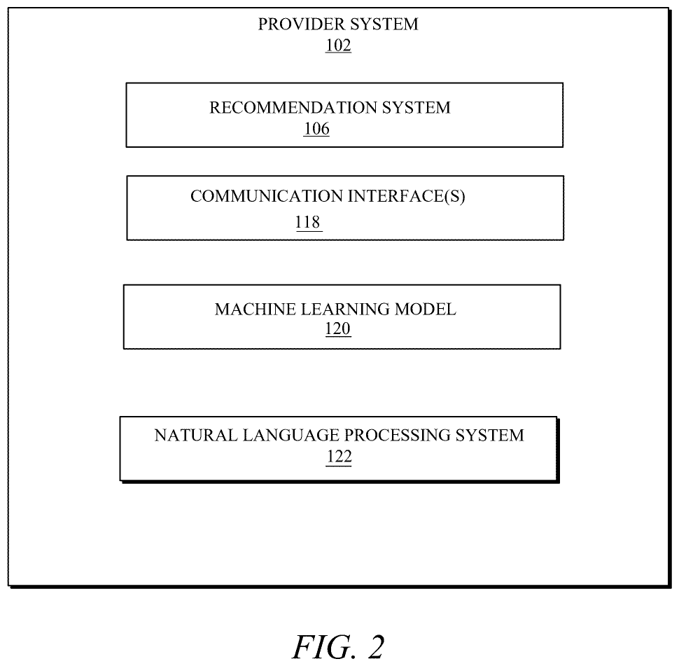

To begin a detailed description of an example query system 100 for processing a query, reference is made to FIGS. 1-4. The system 100 can include a provider system 102 configured to generate an interactive query interface. Using the interactive query interface, a query regarding a product and/or service may be captured. For example, the input may be captured via a user device 104 using text, audio, and/or other interaction with the interactive query interface. Upon receiving the query, the provider system 102 processes the query using a recommendation system 106 to generate a response to the query that is sent to the user device 104. In an implementation, the response. The system 100 may further include an enterprise device 108 and one or more databases 110. The provider system 102, the enterprise device 108, and the one or more databases 110 are configured to interact with one another via a network(s) 112. As illustrated in greater detail below, any and/or all of the provider system 102, the recommendation system 106, the enterprise device 108, the user device 104, the one or more databases 110 may, in some instances, be special-purpose computing devices configured to perform specific functions.

The provider system 102 includes one or more computing devices (e.g., servers, routers, user interface devices, internet telephony computing device, and the like) that store and/or retrieve data in the one or more databases 110, provide user interfaces, phone system functionality, execute the recommendation system 106, etc. by processing instructions. The provider system 102 may include a communication interface(s) 118 that is able to communicate with the one or more input systems and one or more output systems via the network(s) 112. For instance, the communication interface(s) 118 may be a network interface configured to support communication between the provider system 102 and the network(s) 112. The one or more input systems and one or more output systems may be part of the user device 104 or separate from the user device 104. In some instances, the provider system 102 further includes a natural language processing system 122. The provider system 102 can be configured to train and maintain the machine learning model 120 to execute the techniques, as discussed in greater detail below. The provider system 102 can be configured to monitor and store (e.g., with appropriate permissions) communication from a user for further analysis and/or training of a machine learning model 120. In an implementation, the provider system 102 is configured to transmit the communication to another computing device or database, such as the one or more databases 110. In an implementation, the provider system 102 is associated with an organization or entity (e.g., an insurance company, a financial services company, etc.). In an implementation, the provider system 102 can retrieve and send policy and/or benefit information that indicates what product or services are currently available to the user.

The user device 104 includes one or more input systems and one or more output systems. The user is able to submit a query to the provider system 102 via the interactive query interface presented on the output system of the user device 104. The interactive query interface changes based on the interactions by the user with the user device 104. The user device 104 can be a computing device (e.g., smartphone, tablet, desktop computer, laptop computer, or other personal computing device) that may be used by an individual (e.g., a customer of an enterprise organization, such as an insurance provider). In some instances, the user device 104 may be used to display a recommendation and/or other alerts/graphical user interfaces.

In an implementation, the machine learning model 120 is trained to support dynamic and configurable conversations with a user with regard to queries related to products and/or services, such as, for example, insurance and financial services. In an implementation, the machine learning model 120 utilizes a transformer neural network architecture, a linear regression model, etc. The machine learning model 120 may be built from historical conversation data stored, for example, at the one or more databases 110. In this implementation, the machine learning model 120 leverages historical conversational data relating to product and/or service between a consumer and an employee of the provider, such as, for example, an agent, a salesperson, a customer service representative, etc. For instance, the training set can include conversational data that resulted in a successful sale of a product or service, a high satisfaction rating from the consumer, etc. In an implementation, the conversational data is weighted such that conversational data leading to a successful sale is weighted higher than conversational data that led to a high satisfaction rating. In an implementation, the conversational data include location data, such as for example, using geotags. The conversational data can be from a phone call, chat session, e-mail, etc. Accordingly, the machine learning model 120 allows the recommendation system 106 to conduct a conversation with a consumer that brings the best parts of conversing with a real human without the pressure associated that consumers may feel when conversing with a real human, while still increasing the likelihood of a successful sale of the product or service.

In an implementation, the recommendation system 106 includes instructions that direct and/or cause the natural language processing system 122 to execute processing techniques on the request before generating a query that is input into the machine learning model 120. For instance, a large language model (LLM) may be used to process the query. In an implementation, the recommendation system 106 includes further instructions that direct and/or cause the natural language processing system 122 to execute processing techniques on a response generated by the machine learning model 120 before transmitting the response to the user device 104. For instance, a large language model (LLM) may be used to process the response. In an implementation the natural language processing system 122 utilizes location data of the user to generate a response using colloquial language of a region of the user. In another implementation, the query is processed using sentiment analysis to determine if the query should be directed to a real person. If the sentiment analysis determines the user frustration (using for example a tone of the user) is above a threshold, a communication is initiated between the user and the real person (e.g., an agent). In another implementation, the response is processed to use a desired tone of voice of an enterprise. In an implementation, the above-mentioned processing can be processed via models in parallel. The response can be output using text, audio, and/or visual representations, such as, for example, maps, graphs, animations, etc. Based on an analysis of the above-mentioned processing, the recommendation system 106 determines which output to utilize.

The recommendation system 106 is configured to perform one or more of the functions described herein. For example, the recommendation system 106 may include one or more computers (e.g., laptop computers, desktop computers, or servers). The recommendation system 106 may have instructions that direct and/or cause the recommendation system 106 to generate an interactive query interface for presentation using one or more output systems of the user device 104, receive query input associated with at least one of a product or a service captured via one or more input systems of the user device 104 through interaction of a user with the interactive query interface, generate a query based on the query input using the natural language processing system 122, receive user data associated with the user, generate a recommendation based on the user data and the query using the machine learning model 120, cause the interactive query interface to present the recommendation using the one or more output systems, receive a user selection captured via one or more input systems through interaction of a user that indicates the service or the product a user desires to purchase using the recommendation user interface, and provide the product and/or service to the user. In an implementation, the user interface is generated using Generative Artificial Intelligence.

In an implementation, the enterprise device 108 is able to communicate with the user device 104 via the network(s) 112, such as though a phone call, chat session, e-mail, etc. The enterprise device 108 can be a computing device (e.g., smartphone, tablet, desktop computer, laptop computer, or other personal computing device) that may be used by an individual (e.g., an employee of an enterprise organization, such as a customer service representative, salesperson, agent, etc. for an insurance or financial services provider).

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VoIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

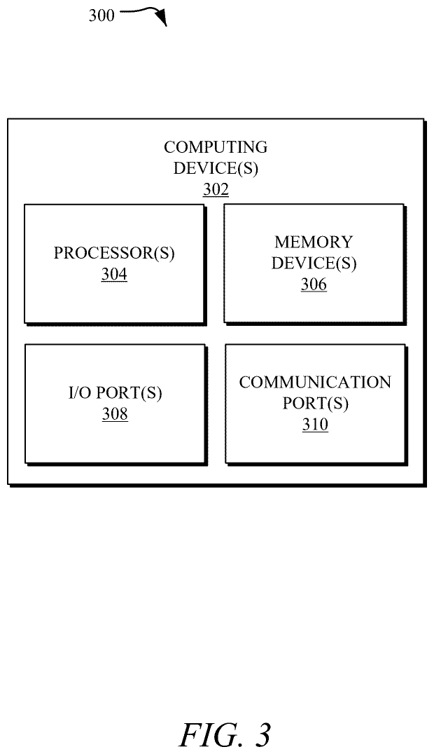

Turning to FIG. 3, a system 300 to process a request can include one or more computing devices 302 for performing the techniques discussed herein. In one implementation, the one or more computing devices 302 include the user device 104, one or more servers of the provider system 101, and/or the enterprise device 108 to generate and execute the recommendation system 106 as a software application and/or a module or algorithmic component of software.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the text communication) and transforms the input data through various stages of the data flow into new types of data files (e.g., generate a recommendation in response to the query). Moreover, these new data files are transformed further into a response to the query relating to a request and sent to the user device 104 to provide an answer to the query regarding the product and/or service to the user, which enables the computing device 302 to do something it could not do before-generate a response to a query relating to a request associated with a complex product and/or service using a machine learning model trained using historical conversational data.

Additionally, the systems and operations disclosed herein represent an improvement to the technical field of human-computer interaction (HCl) and machine learning processing. For instance, the recommendation system 106 can automatically generate a response to a complex query regarding a product and/or service without the need for human intervention in processing the response. Moreover, data can be leveraged from different data sources with varying levels of abstraction to provide a highly customized and conversational responses. These techniques are rooted in technology and could not have existed prior to the advent of natural language processing and/or machine learning analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the recommendation system 106, and/or other software, modules, services, and operations discussed herein may be embodied by instructions stored on the memory device(s) 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

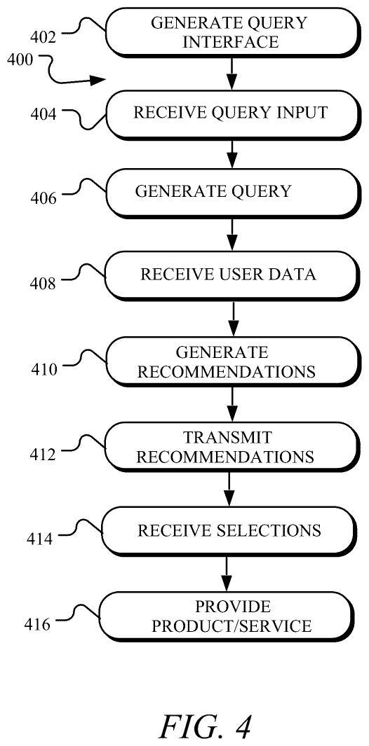

FIG. 4 depicts an example method 400 to generate a response to a query relating to a product and/or service, which can be performed by any of the systems 100-300 discussed herein. The method 400 can, in some instances, occur in real time.

At operation 402, the method 400 can generate an interactive query interface by the recommendation system 106. The interactive query interface can by presented via one or more output systems of the user device 104. In an implementation, the interactive query interface is generated using Generative AI.

At operation 404, the method 400 can receive a query input captured via one or more input systems through interaction of a user with the interactive query interface. The query input is associated with a product and/or service and is a communication inputted by the user via the one or more input systems of the user device 104. In an implementation, the communication is a voice input and/or a textual input. In an implementation, the query input can be related to a quote for the product and/or service. In this instance, the query may state, “start my quote” or “help me choose a product.” In another implementation, the query can be related to asking about a specific product or service. In this instance, the query may state, “tell me about xyz.” In another implantation, the query can be related to discounts. In this instance, the query may state, “tell me about discounts.” In response to the query related to the quote, the provider system 102 can generate an onboarding user interface for display on the user device 104 via the one or more output systems. The onboarding user interface can include fillable forms configured to be filled out by the user using the one or more input systems of the user device 104. In an implementation, the onboarding user interface requests user data such as, name, address, birthdate, coverage level, options, etc.

At operation 406, the method 400 generates a query based on the query input using the natural language processing system 122.

At operation 408, the method 400 receives the user data from at least one of the user device 104 or database(s) 110 and inputs the user data into the machine learning model 120 after being processed by the natural language processing system 122.

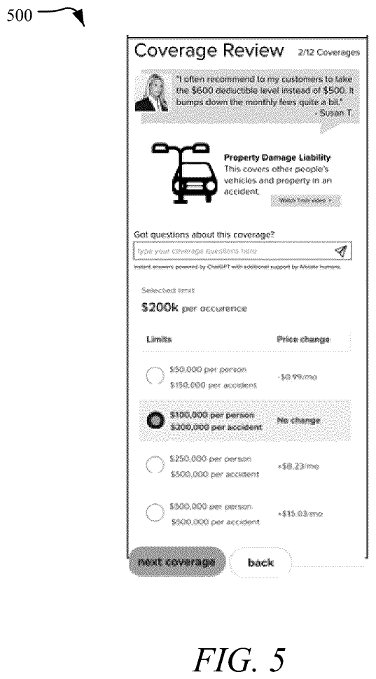

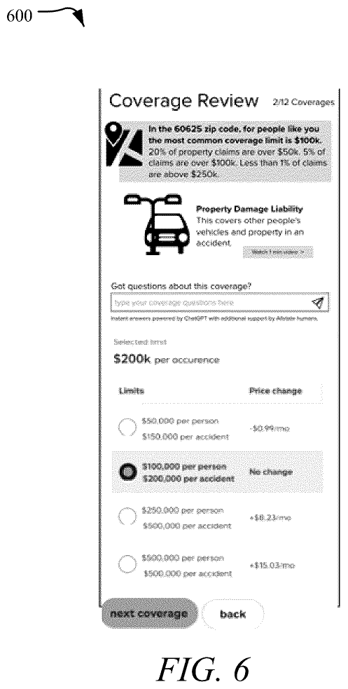

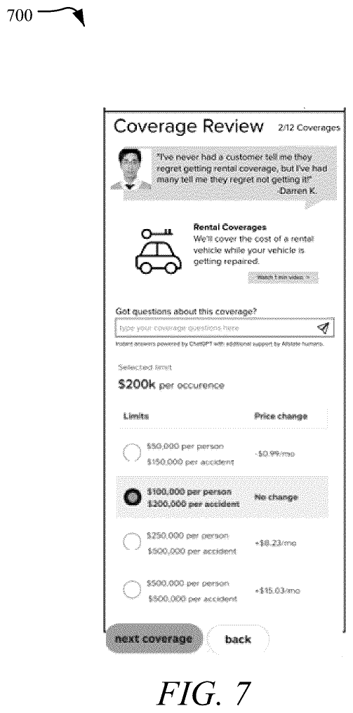

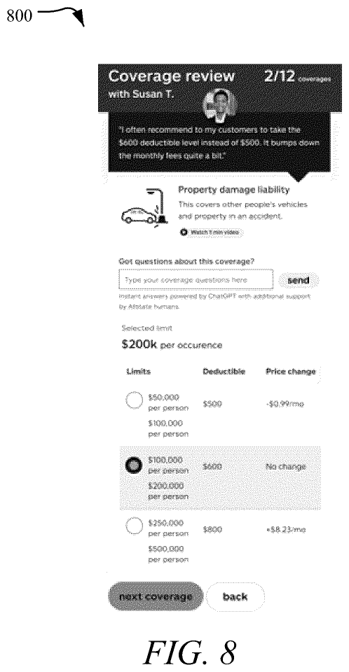

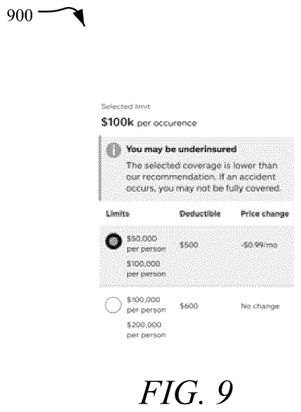

At operation 410, the method 400 generates a recommendation in response to the query and user data using the machine learning model 120. In response to generating the recommendation, the interactive query interface presents the recommendation using the one or more output systems of the user device 104. In an implementation, the recommendation can include multiple recommendations. Example interactive query interfaces 500-900 are shown in FIGS. 5-9. In an implementation, the recommendation is presented by a virtual employee, such as, for example, an agent or a salesperson. In an implementation, the interactive query interface includes one or more of a plurality of selectable products and/or services, a price change compared to a current product and/or service used by the user, an input for an additional inquiry, a recommended additional product and/or service, a statement from the virtual employee, an explanation of the product and/or service, a comparison with products and/or services used by users with similar characteristics as the user, and an indication that a selected product and/or service is below a coverage recommendation.

At operation 412, the method 400 transmits the recommendation to the user device 104 via the network(s) 112. The user device 104 indicates the recommendation via the interactive query interface presented via the one or more output systems. In an implementation, the recommendation output by the machine learning model 120 are processed by the natural language processing system 122 before being transmitted to the user device 104. For instance, the recommendation output is processed using a large language model (LLM).

At operation 414, the method 400 receives a user selection indicating the service and/or product the user desires to purchase via the one or more input systems of the user device 104. In an implementation, the user selection is selected by the user via the interactive query interface displayed on the user device 104.

At operation 416, the method 400 provides the service and/or product to the user. For instance, the method 400 subscribes the user to the service and/or product offered by the provider, such as an insurance policy from an insurance company.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

In an implementation, the recommendation system 106 receives and monitors real-time communication from an employee of the provider to the user via the enterprise device 108. In this implementation, the recommendation generated by the machine learning model 120 is transmitted to the enterprise device 108 to provide real-time guidance to the employee, while the employee is communicating with the user.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A query system comprising:
a provider system in communication with a user device over a network, the user device having one or more input systems and one or more output systems, the provider system configured to generate an interactive query interface, the provider system receiving query input captured via the one or more input systems through interaction of a user with the interactive query interface, the provider system receiving user data from the user device;
a natural language processing system configured to generate a query based on the query input, the query associated with at least one of a product or a service; and
a recommendation system having a machine learning model, the recommendation system configured to generate a recommendation based on the user data and the query using the machine learning model, the provider system configured to send the recommendation to the user device to cause the recommendation to be presented with the interactive query interface using the one or more output systems.

2. The query system of claim 1, wherein the interactive query interface includes an onboarding user interface configured to capture the user data.

3. The query system of claim 1, wherein the interactive query interface is configured to capture a user selection using the one or more input systems, the user selection indicating at least one of the product or the service a user desires to purchase.

4. The query system of claim 1, wherein the interactive query interface includes at least one of a plurality of selectable products or services, a price change compared to a current product or service, an input for an additional inquiry, a recommended additional product or service, a statement from a virtual employee, an explanation of at least one of the product or the service, a comparison with a product or a service used by users with similar characteristics, or an indication that a user selection is below a recommendation.

5. The query system of claim 1, wherein the user data includes at least one of a name of a user, an address of the user, a birthdate of the user, or a desired coverage level.

6. The query system of claim 1, wherein the one or more input systems and the one or more output systems are integrated into the user device.

7. The query system of claim 1, wherein the recommendation is processed by natural language processing system before being sent to the user device.

8. A computer implemented method comprising:
generating an interactive query interface for presentation using one or more output systems;
receiving query input associated with at least one of a product or a service, the query input captured via one or more input systems through interaction of a user with the interactive query interface;
generating a query based on the query input using a natural language processing system;
receiving user data associated with the user;
generating a recommendation based on the user data and the query using a machine learning model; and
causing the interactive query interface to present the recommendation using the one or more output systems.

9. The computer implemented method of claim 8, further comprising:
generating an onboarding user interface in response to receiving the query; and
causing the interactive query interface to present the onboarding user interface, wherein the user data is captured using the onboarding user interface.

10. The computer implemented method of claim 8 further comprising:
receiving a user selection indicating the service or the product a user desires to purchase, the user selection captured via one or more input systems through interaction of a user with the interactive query interface.

11. The computer implemented method of claim 8, wherein the interactive query interface includes at least one of a plurality of selectable products or services, a price change compared to a current product or service, an input for an additional inquiry, a recommended additional product or service, a statement from a virtual employee, an explanation of the product or the service, a comparison with a product or a service used by users with similar characteristics as a user associated with the one or more output systems, or an indication that a user selection is below a coverage recommendation.

12. The computer implemented method of claim 8, wherein the user data includes at least one of a name of a user, an address of the user, a birthdate of the user, or a desired coverage level.

13. The computer implemented method of claim 8, wherein the machine learning model is trained using historical conversational data relating to the at least one of the product or the service.

14. The computer implemented method of claim 8, wherein the one or more output systems form a part of a user device.

15. One or more tangible non-transitory computer-readable storage media storing computer-executable instructions for performing a computer process on a computing system, the computer process comprising:
generating an interactive query interface for presentation using a user device;
receiving query input associated with at least one of a product or a service, the query input captured via the user device through interaction of a user with the interactive query interface;
generating a query based on the query input using a natural language processing system;
receiving user data associated with the user;
generating a recommendation based on the user data and the query using a machine learning model; and
causing the interactive query interface to present the recommendation using one or more output systems.

16. The one or more tangible non-transitory computer-readable storage media storing computer-executable instructions for performing the computer process on the computing system of claim 15, wherein the interactive query interface includes one or more of a plurality of selectable products or services, a price change compared to a current product or service, an input for an additional inquiry, a recommended additional product or service, a statement from a virtual employee, an explanation of at least one of the product or the service, a comparison with a product or a service used by users with similar characteristics, and an indication that a user selection is below a recommendation.

17. The one or more tangible non-transitory computer-readable storage media storing computer-executable instructions for performing the computer process on the computing system of claim 15, wherein the machine learning model is trained using historical conversational data relating to at least one of selling or explaining products or services to consumers.

18. The one or more tangible non-transitory computer-readable storage media storing computer-executable instructions for performing the computer process on the computing system of claim 15, wherein the one or more output systems form a part of a user device.

19. The one or more tangible non-transitory computer-readable storage media storing computer-executable instructions for performing the computer process on the computing system of claim 15, wherein the user data includes one or more of a name of a user, an address of the user, a birthdate of the user, and a desired coverage level.

20. The one or more tangible non-transitory computer-readable storage media storing computer-executable instructions for performing the computer process on the computing system of claim 15, wherein the computer process further comprises:
generating an onboarding user interface in response to receiving the query; and
causing the interactive query interface to present the onboarding user interface, wherein the user data is captured using the onboarding user interface.
